(19) United States
(12) Patent Application Publication
(10) Pub. No.: US 2002/0180237 A1
(43) Pub. Date: Dec. 5, 2002

(54) Drive mechanism for power operated slideable side door and roller and hinge assembly therefor

(76) Inventors: Lloyd W. Rogers, Shelby TWP., MI (US); Michael T. Moury, Shelby TWP., MI (US); David J. Chapman, Sterling Heights, MI (US)

Correspondence Address: Kathryn A. Marra, Delphi Technologies, Legal Staff - M/C: 480-414-420, P.O. Box 5052, Troy, MI, 48007-5052, US

(21) Appl. No.: 10/092,691

(22) Filed: Mar. 7, 2002

Related U.S. Application Data
(60) Provisional application No. 60/295,606, filed on Jun. 4, 2001.

(51) Int. Cl. B60J 5/06

(52) U.S. Cl. 296/155

(57) ABSTRACT

A passenger van is equipped with a drive mechanism for power operation of a slideable side door. The drive mechanism has an endless flexible drive member that travels in a closed loop which includes travel through a lower track that supports and guides a hinge and roller assembly that is attached to the lower front corner of the side door. A clutch is mounted on the hinge and roller assembly to clamp onto the flexible drive member for power operation. The clutch is released by an actuator that maintains the clutch disengaged until the clutch is automatically re-engaged when the side door is closed or opened completely.

### RELATED APPLICATION

This patent application claims benefit of U.S. Provisional patent application No. 60/295,606 filed Jun. 4, 2001.

### FIELD OF THE INVENTION

This invention relates to automotive vehicles having a slideable side door and more particularly to a drive mechanism for a power operated slideable side door and a roller and hinge assembly for the drive mechanism.

### BACKGROUND OF THE INVENTION

U.S. Pat. No. 5,316,365 granted to Howard W. Kuhlman and Jeffrey K. Joyner May 31, 1994 discloses a passenger van that has a slidable side door. The door is supported on and slideable in three tracks. A module for power operation of the door is mounted inside the van adjacent to the center track that supports and guides the rear of the door. The module includes a front cable and a rear cable. The front cable is attached to a front cable drive pulley, then extends through a front cable roller guide assembly and is then attached to a hinge and roller assembly. The rear cable is attached to a rear cable drive pulley then extends through a rear cable roller guide, assembly, and is then attached to the hinge and roller assembly. The front and rear cable drive pulleys are driven by an electric motor via an electromagnetic clutch to open and close the sliding door. The electromagnetic clutch permits manual opening and closing of the side door when it is disengaged, thus avoiding the need to backdrive the electric motor. However, the cables and pulleys must be backdriven during manual operation.

Copending patent application Ser. No. 09/867,863, filed May 30, 2001, discloses a drive mechanism for power operation of a slideable side door of an automotive vehicle that is characterized by a hinge and roller assembly that includes a clutch for clamping an electric motor driven flexible drive member that travels in a loop. The clutch is operated manually from a remote location. Arrangement is an improvement in that the cables and pulleys need not be backdriven when the clutch is disengaged. However, the clutch must be reengage for power operation. Furthermore, it is possible to reengage the clutch is open part way thus making it difficult to the fully open or close the door.

Copending patent application Ser. No. 09/978,908, filed Oct. 16, 2001, discloses another improved system that avoids the problem of reengaging the clutch when the door is part way open. However, this arrangement requires that the door be returned to the uncoupling position before the clutch can be reengaged.

### SUMMARY OF THE INVENTION

This invention provides a drive mechanism for power operation of a slideable side door of an automotive vehicle, such as a passenger van. The drive mechanism has an electric motor driven flexible drive member that travels in a closed loop, a portion of which is through a track that supports and guides a hinge and roller assembly that is attached to the door. The hinge and roller assembly has a normally engaged clutch that is actuated to clamp the hinge and roller assembly to the flexible drive member for power operation of the door. The drive mechanism provides for remote disengagement of the clutch to reduce manual operation effort by eliminating the need to back drive either the flexible drive member or the pulleys or the electric motor. The drive mechanism also preferably provides for automatic reengagement of the clutch when the manually operated door is closed or fully opened.

### BRIEF DESCRIPTION OF THE DRAWINGS

FIG. 1 is a side view of a passenger van equipped with sliding side doors that are power operated by a drive mechanism of the invention;

FIG. 2 is a schematic perspective view of the power operated drive mechanism for opening and closing the sliding side doors of the passenger van shown in FIG. 1;

FIG. 3 is an enlarged top view of a hinge and roller assembly in the drive mechanism shown in FIG. 2 with the parts positioned for power operation; and

FIG. 4 is an enlarged top view of a hinge and roller assembly in the drive mechanism shown in FIG. 2 with the parts positioned for manual operation.

### DESCRIPTION OF THE PREFERRED EMBODIMENT

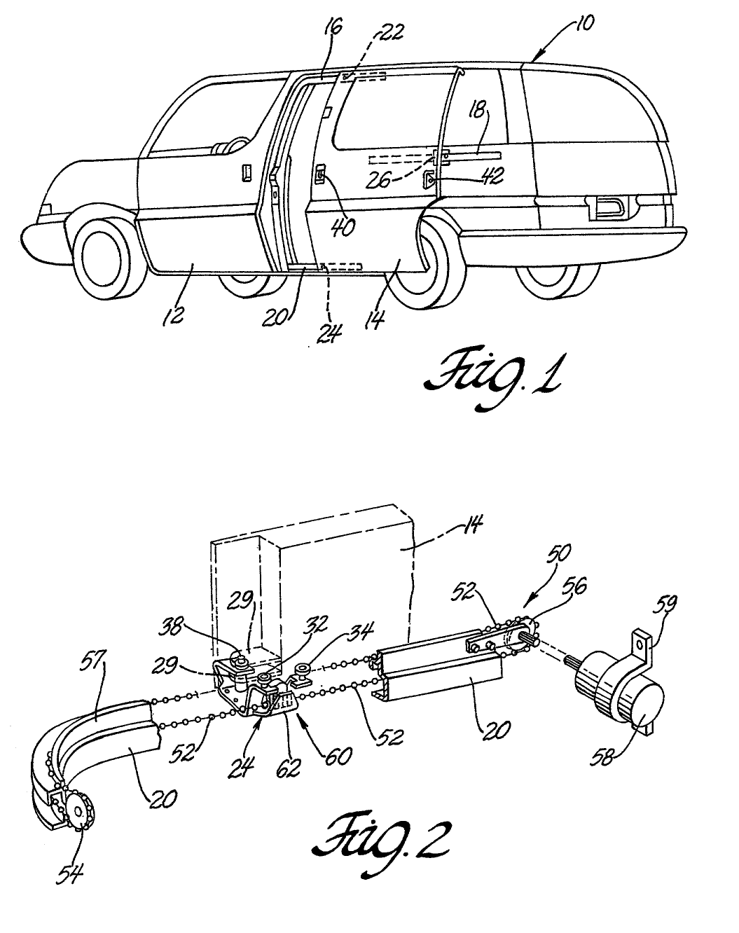

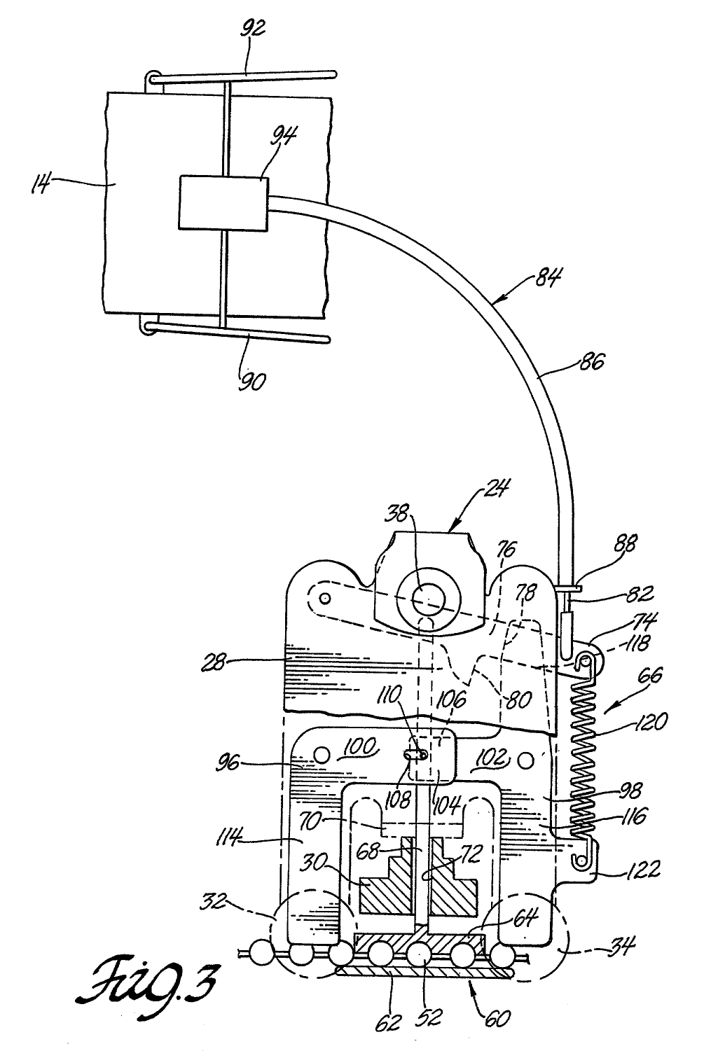

Referring now to FIGS. 1 and 2, an automotive vehicle, such as a passenger van 10 has a hinged front door 12 on each side of the vehicle and at least one sliding side door 14 behind the front doors that may be power driven. Historically, a sliding side door was provided on the passenger side only. However, sliding side doors are now usually provided on the driver side as well as the passenger side. In any event, such vehicles are well known and need not be described in detail. See for instance the Kuhlman '365 patent discussed above.

The power sliding door 14 on the driver side is supported and guided by an upper track 16, a center track 18, and a lower track 20 as shown in FIG. 1. An upper hinge and roller assembly 22 is attached to the upper forward corner of the power sliding door and runs in the upper track 16. A lower hinge and roller assembly 24 is attached to the lower forward corner of the power sliding door and runs in the lower track 20. A central hinge and roller assembly 26 is pivotally attached to the rear portion of the power sliding door 14 between the upper and lower portions of the power sliding door. Hinge and roller assembly 26 runs in center track 18.

An identical sliding door 14 which is the mirror image of the sliding door 14 is provided on the passenger side as shown in FIGS. 2, 3 and 4. The lower hinge and roller assembly 24 has a carriage 28. A support roller 30 pivotally attached to carriage 28 for rotation about a generally horizontal axis, supports the lower front corner portion of door 14 and runs in the lower track 20. Two guide rollers 32 and 34 are pivotally attached to carriage 28 for rotation about generally vertical axes and run in an upper channel portion 36 of the lower track 20. A vertical hinge pin 38 passes through a pair of hinge apertures in carriage 28 and through hinge apertures in a bracket 29 attached to the lower front edge of the power sliding door 14 to connect carriage 28 to power sliding door 14.

The power sliding door 14 moves horizontally inward toward the center of the van 10 for latching and sealing. Latches 40 and 42 are provided at the front and rear of the power sliding door 14 which moves horizontally inward to compress resilient seals and to latch as shown in FIG. 1. Inward horizontal movement of the sliding door 14 is obtained by curving the forward ends of the upper, center and lower tracks 16, 18 and 20 inwardly toward the center of van 10. When the hinge and roller assembly 24 passes around the curved forward end 44 of lower track 20, the hinge and roller assembly 24 pivots inwardly and moves the front portion of side door 14 horizontally inward toward the side of van 10.

The drive mechanism 50 for opening and closing the side door 14 comprises the hinge and roller assembly 24 and further includes a flexible drive member 52. Flexible drive member 52, which may be a beaded cable, travels in a closed loop with a portion of the loop disposed in track 20 along the entire length of the track as best shown in FIG. 2. The portion of the loop disposed in track 20 travels in close proximity to the hinge and roller assembly 24. A front pulley 54 engages the flexible, drive member 52 at a front end of track 20 and a rear pulley 56 engages the flexible drive member 52 at a rear end of the track 20. A portion of the loop that is disposed outside the track 20 runs between pulleys 54 and 56. The portion is guided by a fence 57 or some other guide that may or may not be an integral part of track 20. An electric motor 58 attached to van 10 by a bracket 59 drives one of the pulleys, preferably rear pulley 56 which usually has a roomier environment. In any event, the driver pulley is preferably shaped to mate with the profile of the flexible drive member, for example, by matching the periphery of the pulley to mate with the profile of the beaded cable as shown in FIG. 2.

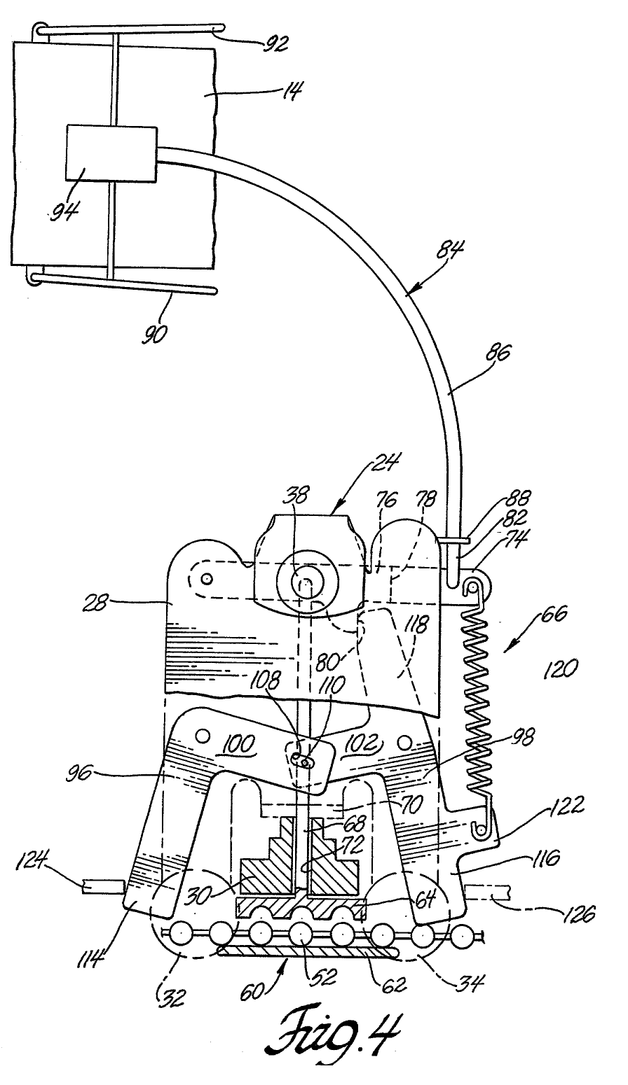

The hinge and roller assembly 24 includes a clutch 60 for clamping the hinge and roller assembly 24 to the flexible drive member 52 as best shown in FIGS. 3 and 4. Clutch 60 comprises a stationary plate 62 at an inner end of carriage 28, a moveable plate 64, and an actuator 66 Clutch 60 is normally engaged as shown in FIG. 3 with plates 62 and 64 straddling and clamping a portion of the flexible drive member 52 that is in track 20 for driving side door 14 to the open position or to the closed position. Actuator 66 provides for moving moveable plate 64 away from stationary plate 62 and the clamped or engaged position of FIG. 3 to the release or disengaged position of FIG. 4 where flexible drive member 52 is released by clutch 60 for opening or closing side door 14 manually.

Stationary plate 62 is preferably flat while moveable plate 64 is preferably grooved to mate with the profile of the beaded cable that is used as the flexible drive member 52. Actuator 66 comprises a rod 68 that is attached to plate 64 that slides in a guide 70 of carriage 28 and extends through a bore 72 of support roller 30 that is supported rotationally on carriage 28. The remote end of rod 68 is pivotally attached to the middle of a transfer lever 74 that is pivotally attached to carriage 28 at one end. Transfer lever 74 has a medial embossment 76 that includes a rearward stop shoulder 78 and a forward two way stop shoulder 80. The free end of transfer lever 74 is attached to the core 82 of a conventional push-pull cable 84 that has a jacket 86 that has one end attached to the carriage 28 by a fastener 88. Push-pull cable 84 is operated by inside and outside door handles 90 and 92 via a suitable linkage that is represented schematically at 94 in FIG. 3. Linkage 94 is inside side door 14 and connected to the opposite end of push-pull cable 84.

Actuator 66 further includes forward and rearward bell crank levers 96 and 98 that are pivotally attached to carriage 28 on either side of rod 68 with their respective arms 100 and 102 extending toward each other with end portions 104 and 106 that overlap each other. End portions 104 and 106 are connected together by a pin and slot arrangement comprising a slot 108 in end portion 104 that receives a pin 110 of end portion 106. The pin and slot arrangement which coordinates the rotation of bell crank levers 96 and 98, can be reversed or replaced by other arrangements that coordinate rotation of bell crank levers 96 and 98.

The second arms 114 and 116 of bell crank levers 96 and 98 extend toward stationery plate 62 and the interior side of track 20. Aims 114 and 116 are generally parallel when clutch 60 is engaged and the bell crank levers 114 and 116 are in a triggered position as shown in FIG. 3.

The rearward bell crank lever 98 has a third arm 118 that acts as a detent that cooperates with stop shoulders 78 and 80 of transfer lever 74 as explained below. A coil spring 120 has one end attached to transfer lever 74 and the other end attached to a tab 122 extending from arm 116 of rearward bell crank lever 98. Coil spring 120 biases transfer lever 74 clockwise and biases rearward crank lever 98 counterclockwise as viewed in FIGS. 3 and 4.

Drive mechanism 50 operates in the following manner. Clutch 60 is normally engaged as shown in FIG. 3. In order to power open the side door 14, electric motor 58 is energized. When energized electric motor 58 rotates rear pulley 56 clockwise as viewed in FIG. 2 which then drives flexible drive member 52 so that it travels in a closed loop in a clockwise direction. Flexible drive member 52 thus pulls hinge and roller assembly 24 and side door 14 that is attached to the assembly rearward from a closed position to an open position, that is, to the right as viewed in FIG. 2. When side door 14 is fully open, electric motor 58 is de-energized by any well know technique, such as by operating limit switches. Side door 14 is now ready to be closed by power simply by energizing electric motor 58. However, electric motor 58 is now reversed so that the flexible drive member 52 travels counterclockwise in the loop as viewed in FIG. 2 which moves side door 14 to the left to the closed position. When side door 14 is fully closed, electric motor 58 is deenergized.

In the alternative, side door 14 can be closed or opened manually without much effort by operating either the inside door handle 90 or the outside door handle 92 to rotate transfer lever 74 counterclockwise from the engaged position of FIG. 3 to the release position of FIG. 4. This retracts moveable plate 64 via rod 68 releasing the flexible drive member 52 and also releasing arm or detent 118 of rearward bell crank lever 98 from stop shoulder 78. When rear bell crank lever 98 is released, coil spring 120 rotates rearward bell crank lever 98 counterclockwise from the triggered position of FIG. 3 until it engages stop shoulder 80 and stops in the armed position of FIG. 4 due to the coupling of pin 110 in slot 108. As rearward bell crank lever 98 rotates counterclockwise, it in turn rotates forward bell crank lever 96 clockwise from the triggered position of FIG. 3 to the armed position shown in FIG. 4 due to the coupling of pin 110 in slot 108. Side door 14 can now be opened or closed manually with little effort because there is no need to back drive flexible drive member 52, the pulleys 54 and 56 and the electric motor 58. Thus side door 14 may be operated manually without much effort whenever a manual operation is desired or necessary because of a power failure.

It should be noted that once the door handle 90 or 92 rotates transfer lever to the release position of FIG. 4 and the detent arm 118 engages the two-way stop shoulder 80 of transfer lever 74, clutch 60 will stay disengaged even if the door handle 90 or 92 is released because the top of detent arm 118 will engage the two-way stop shoulder 80 when transfer lever 74 tries to rotate clockwise. Thus once the transfer lever 74 is activated, the drive mechanism 50 remains in the manual operating mode without the necessity of holding the door handle 90 or 92 in an actuating position. However, clutch 60 is automatically engaged when side door 14 is opened or closed.

If side door 14 is closed, front bell crank lever 96 engages a stop 124 at the front end of track 20 as side door 14 approaches closure as shown in FIG. 4 As closure is completed, stop 124 rotates front bell crank lever 96 counterclockwise from the armed position of FIG. 4 back to the triggered position of FIG. 3. Forward bell crank lever 76 also rotates rearward bell crank lever 78 clockwise to the triggered position shown in FIG. 3 releasing transfer lever 74 from the two-way stop shoulder 80. Transfer lever 74 is rotated clockwise by spring 120 to the engaged position of FIG. 3 extending moveable plate 64 to engage and clamp flexible drive member 52. The hinge and roller assembly 124 being clamped to the flexible drive member 52, side door 14 is now ready for either power opening or manual opening.

On the other hand if side door 14 is opened completely when clutch 60 is disengaged as shown in FIG. 4, rear bell crank lever 98 engages a stop 126 at the rear end of track 20 as side door 14 approaches complete opening. (Stop 126 is shown out of position in phantom in FIG. 4.) As opening is completed, stop 126 rotates rear bell crank lever 98 clockwise back to the triggered position of FIG. 3. Rear bell crank lever 98 in turn rotates front bell crank lever 96 counterclockwise while releasing transfer lever 74 from the two-way stop shoulder 80. Transfer lever 74 is then rotated clockwise by spring 120 extending moveable plate 64 to engage flexible drive member 52. This clamps the hinge and roller assembly 124 to the flexible drive member 52 and side door 14 is now ready for power or manual opening.

The drive mechanism 50 of the invention has been described in connection with the lower track 20. However, the drive mechanism can also be used with either the upper track 16 or the center track 18. Moreover, while a specific flexible drive member, in the form of a beaded cable 52 has been illustrated, any type of flexible drive member may be used for example, a flexible drive belt, a ball type chain, a link type chain, a toothed belt or a tape drive. A plain cable can even be used if clutch 60 provides sufficient clamping force. Furthermore, while the preferred embodiment is illustrated with only two pulleys 54 and 56 for driving and guiding the flexible drive member 52 additional guides, both stationary and rotary can be used to establish the travel loop for the flexible drive member 52. Moreover, the transfer lever 74 can be manually and remotely operated by any means as the push pull cable 84 operated by inside and outside door handle by a suitable linkage is merely illustrative of one alternative. In other words, while a preferred embodiment of the invention has been shown and described, other embodiments will now become apparent to those skilled in the art. Accordingly, the invention is not to be limited to that which is shown and described but by the following claims.

We claim:

1. A drive mechanism for a power operated slideable side door that is attached to a hinge and roller assembly that travels in a track of a vehicle, the drive mechanism having a flexible drive member that travels in the track juxtaposed the hinge and roller assembly, a front pulley engaging the flexible drive member at a front end of the track, a rear pulley engaging the flexible drive member at a rear end of the track, an electric motor driving one of the pulleys, a clutch mounted on the hinge and roller assembly for clamping the hinge and roller assembly to the flexible drive member, the clutch having a stationary plate and a moveable plate straddling a portion of the flexible drive member, and an actuator for moving the moveable plate with respect to the stationary plate to clamp the portion of the flexible drive member between the stationary plate and the moveable plate for driving the door or to release the flexible drive member for moving the door manually without back driving the flexible drive member, characterized in that:
the actuator further includes a rod that moves the moveable plate and a transfer lever that is pivotally attached to the hinge and roller assembly and moves the rod.

2. The drive mechanism as defined in claim 1 wherein the transfer lever pivots between an engaged position where the moveable plate clamps the flexible drive member and a release position where the moveable plate releases the flexible drive member and wherein the transfer lever is spring biased toward the engaged position where the moveable plate clamps the flexible drive member.

3. The drive mechanism as defined in claim 2 wherein the actuator further includes a push pull cable that is attached to the transfer lever for pivoting the transfer lever between the engaged position and the release position.

4. A drive mechanism for a power operated slideable side door that is attached to a hinge and roller assembly that travels in a track of a vehicle, the drive mechanism having a flexible drive member that travels in the track juxtaposed the hinge and roller assembly, a front pulley engaging the flexible drive member at a front end of the track, a rear pulley engaging the flexible drive member at a rear end of the track, an electric motor driving one of the pulleys, a clutch mounted on the hinge and roller assembly for clamping the hinge and roller assembly to the flexible drive member, the clutch having a stationary plate and a moveable plate straddling a portion of the flexible drive member, and an actuator for moving the moveable plate with respect to the stationary plate to clamp the portion of the flexible drive member between the stationary plate and the moveable plate for driving the door or to release the flexible drive member for moving the door manually without back driving the flexible drive member, characterized in that:
the actuator further includes a rod that moves the moveable plate and a transfer lever that is pivotally attached to the hinge and roller assembly and moves the rod;
the transfer lever pivots between an engaged position where the moveable plate clamps the flexible drive member and a release position where the moveable plate releases the flexible drive member, and
the actuator includes front and rear bell crank levers that are pivotally attached to the hinge and roller assembly on either side of the rod, the bell crank levers having a triggered position holding the transfer lever in the engaged position and an armed position holding the transfer lever in the release position.

5. The drive mechanism as defined in claim 4 wherein the bell crank levers are operatively connected for coordinated movement and wherein one of the bell crank levers has a detent that engages a first shoulder of the transfer lever to hold the transfer lever in the engaged position and the bell crank levers in the triggered position.

6. he drive mechanism as defined in claim 5 wherein the detent engages a second stop shoulder on the transfer lever to hold the bell crank levers in the armed position when the transfer lever is in the release position.

7. The drive mechanism as defined in claim 6 wherein the bell crank levers are spring biased toward the armed position.

8. The drive mechanism as defined in claim 7 wherein a coil spring is attached to the transfer lever and to one of the bell crank levers to bias the transfer lever toward the engaged position and the bell crank levers toward the armed position.

9. The drive mechanism as defined in claim 7 wherein the bell crank levers have arms that extend toward each other, the arms having end portions that overlap each other and that are connected to each other by a pin and slot arrangement.

10. The drive mechanism as defined in claim 7 wherein the track has a first stop that engages one of the bell crank levers to move the bell crank levers from the armed position to the triggered position when the door is closed manually and a second stop that engages another on the bell crank levers to move the bell crank levers from the armed position to the triggered position when the door is opened fully manually.

11. A hinge and roller assembly for a drive mechanism for a power operated slideable side door of a vehicle, the hinge ad roller assembly comprising:
a carriage,
a clutch on the carriage having a stationery plate and a movable plate,
an actuator for moving the movable plate with respect to the stationary plate,
the actuator comprising a transfer lever that is pivotally mounted on the carriage and attached to the moveable plate,
the transfer lever having a forward stop and a rearward stop,
forward and rearward bell crank levers that are pivotally mounted on the carriage for rotation about spaced respective pivots,
the bell crank levers having arms that extend toward each other and are coupled together so that the bell crank levers rotate each other,
the bell crank levers having second arms for rotating the respective bell crank levers,
one of the bell crank levers having a third arm engageable with the forward and rearward stops of the transfer lever, and
a spring biasing the third arm into engagement with the forward stop when the transfer lever is in a first position or with the rearward stop when the transfer lever is in a second position.

12. The hinge and roller assembly as defined in claim 11 wherein the spring is connected to the transfer lever at one end and to one of the bell crank levers having the third arm at the other end.

13. The hinge and roller assembly as defined in claim 12 wherein one of the forward and rearward stops is a two-way stop.
